(19) United States
(12) Patent Application Publication
(10) Pub. No.: US 2021/0046802 A1
(43) Pub. Date: Feb. 18, 2021

(54) METHOD FOR COOLING AND/OR HEATING A BODY OR A FLUID IN A MOTOR VEHICLE

(71) Applicant: ARKEMA FRANCE, Colombes (FR)

(72) Inventor: Wissam RACHED, Colombes (FR)

(73) Assignee: ARKEMA FRANCE, Colombes (FR)

(21) Appl. No.: 16/965,533

(22) PCT Filed: Apr. 11, 2019
(86) PCT No.: PCT/FR2019/050857

§ 371 Date: Jul. 28, 2020

(30) Foreign Application Priority Data
Apr. 13, 2018 (FR) 1853272

(51) Int. Cl. B60H 1/32; C09K 5/04

(52) U.S. Cl. CPC B60H 1/32281; C09K 5/048; C09K 2205/24; C09K 2205/126; C09K 5/045

(57) ABSTRACT

A method for cooling and/or heating a body or a fluid in a motor vehicle using a system including a steam compression circuit in which flows a first heat transfer composition and a secondary circuit in which flows a second heat transfer composition. Also, an installation for cooling and/or heating a body or a fluid in a motor vehicle, a use for cooling and/or heating a body or a fluid in a motor vehicle, and a heat transfer composition including one or more heat transfer compounds having a boiling point between 0 and 40° C., chosen from among the hydrochlorofluoroolefins, the hydrofluoroolefins and combinations thereof.

### FIELD OF THE INVENTION

The present invention relates to a method for cooling and/or heating a body or a fluid in a motor vehicle, and to an installation suitable for the implementation of this method. The invention also relates to the use of hydrochlorofluoroolefins and hydrofluoroolefins having a boiling point of 0 to 40° C. for this purpose.

### TECHNICAL BACKGROUND

In motor vehicles, the heat engine comprises a circuit for circulation of a heat-exchange fluid which is used for the cooling of the engine and also for the heating of the passenger compartment. To this end, the circuit comprises in particular a pump and a unit heater in which circulates a stream of air which recovers the heat stored by the heat-exchange fluid in order to heat the passenger compartment.

Furthermore, an air-conditioning system intended to cool the passenger compartment of a motor vehicle comprises an evaporator, a compressor, a condenser, an expansion valve, and a fluid capable of changing state (liquid/gas), commonly termed refrigerant or heat transfer fluid. The compressor, directly driven by the engine of the vehicle using a belt and a pulley, compresses the refrigerant, forcing it back under high pressure and at high temperature toward the condenser. The condenser, by virtue of forced ventilation, brings about the condensation of the gas which arrives in the gaseous state at high pressure and high temperature. The condenser liquefies the gas by virtue of the lowering in temperature of the air which passes through it. The evaporator is a heat exchanger which removes heat from the air which will be blown into the passenger compartment. The expansion valve makes it possible to regulate the flow rate for entry of the gas into the loop via a modification of passage section depending on the temperature and on the pressure in the evaporator. Thus, the hot air coming from the outside is cooled by passing through the evaporator.

The refrigerant traditionally used in motor vehicle air conditioning is 1,1,1,2-tetrafluoroethane (HFO-134a).

However, a large number of HFC fluids, including HFO-134a, may make a harmful contribution to the greenhouse effect. This contribution is quantified by a numerical parameter, the GWP (Global Warming Potential).

Another refrigerant to be used henceforth in heat transfer applications is 2,3,3,3-tetrafluoropropene (HFO-1234yf). However, although HFO-1234yf is a low-GWP fluid, it is deemed to be a flammable fluid.

Document WO 2013/035908 describes a system for controlling the temperature of a vehicle, installed close to an evaporator. This document does not mention specific products for the cooling and/or heating of the vehicle.

Document US 2014/0202671 describes a cooling and/or heating system for an electric or hybrid vehicle, comprising a heat sink whose cooling fluid is HFO-1234yf or a mixture of water and glycol.

Document FR 3008929 describes a thermal conditioning device for a motor vehicle, comprising a refrigerant circuit and two heat-exchange fluid circuits, the refrigerant being HFO-134a or HFO-1234yf, and the heat-exchange fluid being a mixture of water and antifreeze.

Document WO 2007/042621 describes a heat exchanger device comprising a liquid/solid phase change material, which is used for controlling the temperature of a vehicle, a building, a room or even a computer.

Document EP 1598406 describes a latent heat storage material which comprises a liquid/solid phase change material and also graphite for storing energy in the form of latent heat.

Document WO 2016/138463 describes a device for storing electrical energy, which is used to charge vehicles and also electronic devices, at the same time minimizing the risk of fire.

Document WO 2008/001004 describes a temperature control device which is capable of transferring heat from a hot source to a cold source by virtue of a cooling fluid in a closed circuit, for space application.

Document EP 1621389 describes a system for providing a vehicle with electrical energy when the engine of the vehicle has stopped. The system described in the document comprises a thermal energy storage material such as water or brine.

Document EP 2416438 describes a battery module featuring enhanced safety, the module comprising a heat sink mounted on a plurality of stacked battery cells, for controlling the temperature of a hybrid or electric vehicle. This module comprises a phase change material such as a paraffin, polyethylene glycol, or an inorganic hydrate.

Document WO 2012/146368 describes an assembly comprising a refrigerant circuit and a heat-exchange fluid circuit which exchange thermally with one another by means of a refrigerant/heat-exchange fluid exchanger, and also a heat storage device containing a phase change material. This assembly is applied to motor vehicles.

Document WO 98/13222 describes a unit for storing and distributing thermal energy for air conditioning and/or heating of a vehicle, which comprises a chamber containing a phase change material such as a paraffin, for example.

Document WO 2007/114615 describes a heat transfer medium circulating in a structure enclosing a battery, the battery being covered with a layer comprising a phase change material.

Document FR 2847973 describes a heat exchanger for a heat-exchange fluid circuit, which is applied to motor vehicle air conditioning evaporators. The evaporator comprises a heat storage fluid formed of a phase change material selected from paraffins, hydrated salts, and eutectic compounds.

Document WO 2011/072988 describes a device and a method for controlling the temperature of a vehicle, comprising at least one phase change material which can be brought into thermal contact with the passenger compartment and with the battery of the vehicle.

Document US 2006/0168991 describes a vehicle air conditioning installation, comprising a compression refrigerant circuit and a heat accumulator which comprises a heat storage medium. The heat storage medium may be, for example, a paraffin.

A need exists for provision of methods for cooling and/or heating a body or a fluid in a motor vehicle that are efficient and safe, while limiting or reducing the amount of flammable products in the vehicle or the closeness of said products to the hottest parts of the vehicle.

### SUMMARY OF THE INVENTION

The invention relates firstly to a method for cooling a body or a fluid in a motor vehicle, by means of a system comprising a first heat transfer composition circulating in a vapor compression circuit and a second heat transfer composition circulating in a secondary circuit, the method comprising:
the transfer of heat from the body or fluid to the second heat transfer composition, leading to the evaporation of this second heat transfer composition;
the transfer of heat from the second heat transfer composition to the first heat transfer composition, leading to the condensation of the second heat transfer composition and the evaporation of the first heat transfer composition.

The invention also relates to a method for heating a body or a fluid in a motor vehicle, by means of a system comprising a first heat transfer composition circulating in a vapor compression circuit and a second heat transfer composition circulating in a secondary circuit, the method comprising:
the transfer of heat from the second heat transfer composition to the body or fluid, leading to the condensation of this second heat transfer composition;
the transfer of heat from the first heat transfer composition to the second heat transfer composition, leading to the evaporation of the second heat transfer composition and the condensation of the first heat transfer composition.

In some embodiments, the fluid is air and the method is preferably a method for air-conditioning the passenger compartment of the vehicle or for heating the passenger compartment of the vehicle; and/or the body is a battery; and/or the body is one or more electronic components.

In some embodiments, the first heat transfer composition comprises 2,3,3,3-tetrafluoropropene.

In some embodiments, the second heat transfer composition comprises one or more heat transfer compounds having a boiling point of 0 to 40° C., preferably chosen from hydrochlorofluoroolefins, hydrofluoroolefins, and combinations thereof; more preferably chosen from 1-chloro-3,3,3-trifluoropropene, preferably in E form; 1-chloro-2,3,3,3-tetrafluoropropene, preferably in Z form, and 1,1,1,4,4,4-hexafluorobut-2-ene in E and/or Z form.

In some embodiments, the second heat transfer composition is at an essentially uniform pressure in the secondary circuit, said pressure being preferably equal to the saturation pressure of the second composition.

In some embodiments, the motor vehicle is an electric or hybrid vehicle.

The invention also relates to an installation for cooling and/or heating a body or a fluid in a motor vehicle, comprising:
a first heat transfer composition circulating in a vapor compression circuit; and
a second heat transfer composition circulating in a secondary circuit;
   the vapor compression circuit being coupled with the secondary circuit by an intermediate heat exchanger, so as to evaporate the first heat transfer composition and to condense the second heat transfer composition, and/or to condense the first heat transfer composition and to evaporate the second heat transfer composition; and the installation comprising an additional heat exchanger configured for transferring the heat of the body or fluid to the second heat transfer composition by evaporating the second heat transfer composition, and/or configured for transferring heat of the second heat transfer composition to the body or fluid by condensing the second heat transfer composition.

In some embodiments, the secondary circuit does not comprise a compressor.

In some embodiments, the vapor compression circuit is reversible and further comprises means for reversing its operation.

In some embodiments, the circulation of the second heat transfer composition in the secondary circuit after condensation thereof is performed by means of a pump, or by gravity, or by capillarity.

In some embodiments, the secondary circuit comprises a plurality of additional heat exchangers, configured for cooling and/or heating a plurality of bodies or fluids preferably from among air, the passenger compartment, the battery, and the electronic components of the vehicle.

In some embodiments, the installation is adapted for the air-conditioning of the passenger compartment of the vehicle, and/or the heating of the passenger compartment of the vehicle, and/or for the cooling of the battery of the vehicle, and/or the heating of the battery of the vehicle and/or the cooling of the electronic compounds of the vehicle; and/or the heating of the electronic compounds of the vehicle.

In some embodiments, the first heat transfer composition comprises 2,3,3,3-tetrafluoropropene.

In some embodiments, the second heat transfer composition comprises one or more heat transfer compounds having a boiling point of 0 to 40° C., preferably chosen from hydrochlorofluoroolefins, hydrofluoroolefins, and combinations thereof; more preferably chosen from 1-chloro-3,3,3-trifluoropropene, preferably in E form; 1-chloro-2,3,3,3-tetrafluoropropene, preferably in Z form, and 1,1,1,4,4,4-hexafluorobut-2-ene in E and/or Z form.

The invention also relates to a use, for cooling and/or heating a body or a fluid in a motor vehicle, of a heat transfer composition comprising one or more heat transfer compounds having a boiling point of 0 to 40° C., chosen from hydrochlorofluoroolefins, hydrofluoroolefins, and combinations thereof.

In some embodiments, the hydrochlorofluoroolefin is chosen from 1-chloro-3,3,3-trifluoropropene and 1-chloro-2,3,3,3-tetrafluoropropene, the 1-chloro-3,3,3-trifluoropropene being preferably in E form, and the 1-chloro-2,3,3,3-tetrafluoropropene being preferably in Z form; and the hydrofluoroolefin is 1,1,1,4,4,4-hexafluorobut-2-ene in E and/or Z form.

In some embodiments, the heat transfer composition undergoes neither compression nor expansion; and the heat transfer composition exchanges heat preferably with another heat transfer composition; which circulates in a vapor compression circuit.

In some embodiments, the use is for the air-conditioning of the passenger compartment of the vehicle, and/or the heating of the passenger compartment of the vehicle, and/or for the cooling of the battery of the vehicle, and/or the heating of the battery of the vehicle and/or the cooling of the electronic compounds of the vehicle, and/or the heating of the electronic compounds of the vehicle.

The present invention makes it possible to satisfy the need expressed above. More particularly, it provides a method for cooling and/or heating a body or a fluid in a motor vehicle that is efficient and safe. Where appropriate, it enables the limitation or reduction of the amount of flammable products in the vehicle or the closeness of these products to the hottest parts of the vehicle. According to some aspects of the invention, this is accomplished through the use of two heat transfer compositions, one circulating in a vapor compression circuit and the other circulating in a secondary circuit, with the heat transfer composition in the secondary circuit evaporating and condensing in order to perform the required transfers of heat with the desired body or fluid. The heat transfer composition in the secondary circuit preferably contains no flammable heat transfer compound; or this composition is non-flammable. More particularly, when HFO-1234yf is used as heat transfer fluid in the vapor compression circuit, the use of the secondary circuit enables a limitation of the extent of the vapor compression circuit and a reduction in the amount of HFO-1234yf used; and/or the prevention of closeness of the HFO-1234yf to the hottest elements of the vehicle or elements which are subject to high electrical voltage, thereby reducing the risks of leakage and of fire. Moreover, the use of a secondary circuit facilitates the heat management of the vehicle. More particularly, and using electric automobiles as an example, there are numerous sources of heat (battery, electrical and electronic circuit, engine) and also numerous consumers of heating and/or cooling (battery, passenger compartment) at different temperature levels. The use of a secondary circuit comprising a heat transfer fluid facilitates the heat management of these apparatuses relative to other technologies.

In some embodiments, the use of the secondary circuit also makes it possible to reduce the energy consumption through a low pumping power, relative to the use of a single-phase heat-exchange fluid.

In some embodiments, the use of the secondary circuit comprising the second heat transfer composition allows the vehicle to be made lighter, avoiding the use of solid phase change materials for performing the heat exchanges.

In some embodiments, the second heat transfer composition does not contain any flammable heat transfer compounds, or is at least non-flammable, and may therefore also serve as an extinguishing agent in the event of overheating of the battery of the vehicle.

### BRIEF DESCRIPTION OF THE FIGURES

FIG. 1 represents schematically one embodiment of an installation according to the invention.

### DESCRIPTION OF EMBODIMENTS OF THE INVENTION

The invention is now described in greater detail and in a nonlimiting manner in the description which follows.

The invention relates to a heat transfer method for cooling and/or heating a body or a fluid in a motor vehicle, implemented by means of a heat transfer installation. The installation contains a first and a second heat transfer composition, each heat transfer composition comprising a heat transfer fluid, which comprises one or more heat transfer compounds.

The term “heat transfer compound” is intended to mean a compound capable of absorbing heat by evaporating and of releasing heat by condensing, in the application under consideration.

In the context of the invention, “HFO-1234yf” refers to 2,3,3,3-tetrafluoropropene, “HCFO-1233zd” refers to 1-chloro-3,3,3-trifluoropropene, “HCFO-1224yd” refers to 1-chloro-2,3,3,3-tetrafluoropropene, and “HFO-1336mzz” refers to 1,1,1,4,4,4-hexafluorobut-2-ene.

The motor vehicle may be a combustion-powered, electric, or hybrid vehicle, preferably an electric or hybrid vehicle. It comprises at least one motor unit, which may be an electric motor or a combustion engine. When the vehicle is electric or hybrid, it comprises an electronic circuit and a traction battery, the latter denoted more simply as “battery” in the text below.

Installation for Cooling and/or Heating in a Vehicle

The invention relates to a method for heat transfer, comprising the cooling and/or the heating of a body or a fluid in a motor vehicle, in a heat transfer installation.

The method according to the invention may therefore be a method for cooling the body or the fluid in the vehicle.

Alternatively, the method according to the invention may be a method for heating the body or the fluid in the vehicle.

Alternatively, the method according to the invention may be a method in which one or more phases of cooling of the body or the fluid alternate with one or more phases of heating of the body or the fluid.

The method according to the invention is implemented by means of the installation set out below.

The heat transfer installation comprises a vapor compression circuit, which contains a first heat transfer composition (or refrigeration circuit), and a secondary circuit, containing a second heat transfer composition (or heat-exchange circuit).

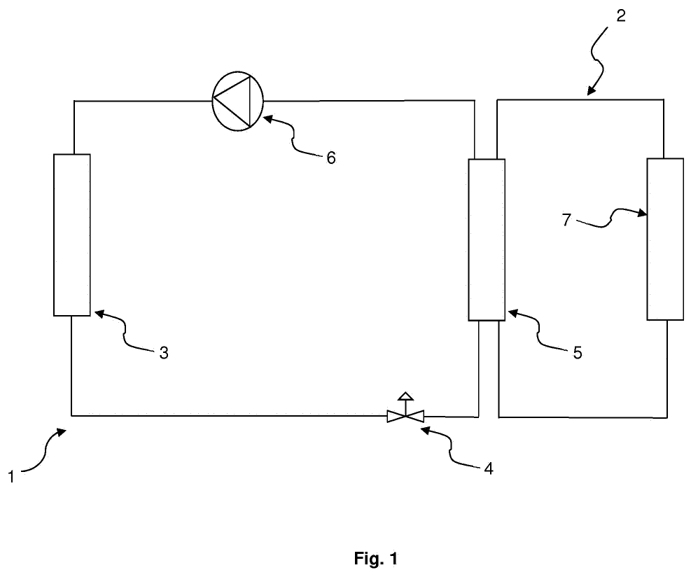

According to one embodiment of the invention, shown schematically in FIG. 1, the vapor compression circuit 1 is coupled with the secondary circuit 2. The vapor compression circuit 1 comprises at least one first heat exchanger 3, an expansion valve 4, an intermediate heat exchanger 5, and a compressor 6. The first heat exchanger 3 is preferably an air/refrigerant exchanger which allows exchange of heat with an energy source such as the ambient air. The secondary circuit 2 comprises at least one additional heat exchanger 7.

By “energy source” is meant a solid and/or liquid and/or gaseous body which is able to absorb or release heat energy according to requirements. The external air, the air in the passenger compartment, the battery, and the electronic circuit of the vehicle represent examples of energy sources.

In refrigeration mode (cooling of a body or fluid in the vehicle), heat is transferred from the body or the fluid of the vehicle to the additional heat exchanger 7, leading to the evaporation of the second heat transfer composition circulating in the secondary circuit 2. The second heat transfer composition subsequently travels into the intermediate heat exchanger 5, which acts as the condenser for the secondary circuit 2. In the vapor compression circuit 1, the first heat transfer composition is compressed by the compressor 6, and passes through the first heat exchanger 3, acting as condenser (that is, it transfers heat energy to a source such as the external air), then through the expansion valve 4, in which it is expanded, and then through the intermediate heat exchanger 5, which acts as evaporator for the vapor compression circuit 1. Thus, in the intermediate heat exchanger 5, heat is transferred from the second heat transfer composition to the first heat transfer composition, leading to the condensation of the second heat transfer composition and the evaporation of the first heat transfer composition. The first heat transfer composition subsequently travels again to the compressor 6, while the second heat transfer composition travels to the additional heat exchanger 7, and enables the cooling of the body or the fluid in the vehicle.

In heat pump mode (heating of a body or fluid in the vehicle), which is not illustrated in FIG. 1, heat is transferred to the body or fluid in the vehicle from the additional heat exchanger 7, leading to the condensation of the second heat transfer composition circulating in the secondary circuit 2. The second heat transfer composition subsequently travels into the intermediate heat exchanger 5, which acts as evaporator for the secondary circuit 2. In the vapor compression circuit 1, the first heat transfer composition is expanded in the expansion valve 4, and passes through the first heat exchanger 3 acting as evaporator (that is, it absorbs heat energy from a source such as the external air), then through the compressor 6, where it is compressed, and then through the intermediate heat exchanger 5, which acts as condenser for the vapor compression circuit 1. Thus, in the intermediate heat exchanger 5, heat is transferred from the first heat transfer composition to the second heat transfer composition, leading to the condensation of the first heat transfer composition and the evaporation of the second heat transfer composition. The first heat transfer composition subsequently travels again to the expansion valve 4, while the second heat transfer composition travels to the additional heat exchanger 7, and enables the heating of the body or the fluid in the vehicle.

In some embodiments, a single heat exchanger may take on the function of the intermediate exchanger 5 or the first heat exchanger 3 described above, depending on the operating mode. Supplementary exchangers may also be added in order to take on the same functions. A system of pipes and valves may be used to provide for the change in function for each exchanger.

In some embodiments, the vapor compression circuit 1 is reversible and may further comprise means for reversing its operation.

The means for reversing the operation of the reversible vapor compression circuit 1 are means for reversing the operation of the vapor compression circuit 1 between a configuration in refrigeration mode and a configuration in heat pump mode.

The aforementioned reversal means may be means for modifying the pathway of the first heat transfer composition in the reversible vapor compression circuit 1, or means for reversing the direction of circulation of the first heat transfer composition in said circuit 1.

The abovementioned reversal means can be a four-way valve, a switchover valve, a shut-off (on/off) valve, an expansion valve, or combinations thereof.

For example, during the reversal of the operating mode of the vapor compression circuit 1, the role of a heat exchanger may be changed: for example, a heat exchanger may act as a condenser in a refrigeration mode or as an evaporator in a heat pump mode, or vice versa.

Alternatively, during the reversal of the operating mode of the vapor compression circuit 1, the role of a heat exchanger may remain the same. Since the heat exchanger is quite simply connected to other energy sources, by way of valves, it is able to absorb or release heat energy according to its function in the vapor compression circuit 1.

In some embodiments, the first heat transfer composition is able to circulate in a single direction in the vapor compression circuit 1.

In some embodiments, the first heat transfer composition is able to circulate in both directions in the vapor compression circuit 1, namely in a first direction and in an opposite direction.

The reversible vapor compression circuit 1 may typically contain pipes, tubes, hoses, a tank, or other means, in which the first heat transfer composition circulates, between the various exchangers, expansion valves, other valves, etc.

According to the operating mode of the vapor compression circuit 1—refrigeration or heat pump—the first heat exchanger 3 may act as evaporator or as energy recuperator (condenser). The same applies to the intermediate heat exchanger 5.

It is possible to use any type of heat exchanger in the vapor compression circuit 1, and especially cocurrent heat exchangers or, preferably, countercurrent heat exchangers.

According to one preferred embodiment, the invention provides for the cooling and heating methods and the corresponding installations to comprise a heat exchanger which is countercurrent with respect either to the first heat exchanger 3 or to the intermediate heat exchanger 5. The reason is that the heat-transfer compositions described in the present patent application are particularly effective with countercurrent heat exchangers. Preferably both the first heat exchanger 3 and the intermediate heat exchanger 5 are countercurrent heat exchangers.

According to the invention, the term “countercurrent heat exchanger” is intended to mean a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, countercurrent heat exchangers include devices in which the flow of the first fluid and the flow of the second fluid are in opposite directions or virtually opposite directions. Exchangers operating in crosscurrent mode with a countercurrent tendency are also included among the countercurrent heat exchangers for the purposes of the present patent application.

The compressor 6 may be hermetic, semihermetic or open. Hermetic compressors comprise a motor part and a compression part, which are contained within an undismantlable hermetic enclosure. Semihermetic compressors comprise a motor part and a compression part, which are assembled directly with one another. The coupling between the motor part and the compression part is accessible by detaching the two parts by dismantling. Open compressors comprise a motor part and a compression part which are separate. They may operate by belt drive or by direct coupling.

The compressor used may especially be a dynamic compressor, or a positive displacement compressor.

Dynamic compressors include axial compressors and centrifugal compressors, which may have one or more stages. Centrifugal mini-compressors may also be employed.

Positive displacement compressors include rotary compressors and reciprocating compressors.

Reciprocating compressors include diaphragm compressors and piston compressors.

Rotary compressors include screw compressors, lobe compressors, scroll (or spiral) compressors, liquid ring compressors, and blade compressors. Screw compressors may preferably be twin-screw or single-screw.

In the installation which is used, the compressor 6 may be driven by an electric motor or by a gas turbine (fed, for example, by the exhaust gases of the vehicle) or by gearing.

In the installation which is used, the compressor 6 may comprise a device for injecting vapor or liquid. Injection entails introducing the refrigerant, in the liquid or vapor state, into the compressor at an intermediate level between the start and the end of compression.

The secondary circuit 2 comprises at least one additional heat exchanger 7.

Each additional heat exchanger 7 may be a fluid/solid exchanger, or fluid/fluid exchanger, or fluid/air exchanger (for heating or cooling the air—for example, the air in the passenger compartment). In these two latter cases, the additional heat exchanger or exchangers 7 may again be cocurrent heat exchangers or, preferably, countercurrent heat exchangers.

The additional heat exchangers 7 may be configured for cooling and/or heating a plurality of bodies or fluids, preferably from among air, especially the air in the passenger compartment, the battery, and electronic components of the vehicle. In order to cool or heat the battery or the electronic components, it is possible to cool or heat the air which is blown toward the battery or the electronic components; or else to place the relevant additional exchanger 7 directly in contact with the battery or the electronic components, or to integrate it in the battery or the electronic components.

In some embodiments, the secondary circuit 2 does not comprise a compressor.

In some embodiments, the second heat transfer composition is at an essentially uniform pressure in the secondary circuit, said pressure being equal to the saturation pressure of the second heat transfer composition at the temperature of the second heat transfer composition. A slight difference is possible in the event of a loss of head. The temperature of the second heat transfer composition is preferably uniform in the secondary circuit.

In some embodiments, the second heat transfer composition remains at a constant temperature during the method.

By “saturation pressure” is meant the pressure at which a gas phase of a composition is at equilibrium with a liquid phase at a given temperature in a closed system.

In some embodiments, the secondary circuit 2 may comprise one or more valves, especially when it comprises several additional heat exchangers 7, so as to orient the second heat transfer composition to one or more specific additional heat exchangers 7; and/or so as to allow a change in the direction of circulation of the second heat transfer composition in all or part of the secondary circuit 2.

In some embodiments, the second heat transfer composition is able to circulate in a single direction in all or part of the secondary circuit 2.

In some embodiments, the second heat transfer composition is able to circulate in both directions in all or part of the secondary circuit 2, namely in a first direction and an opposite direction.

In some embodiments, the circulation of the second heat transfer composition in the secondary circuit 2 from the intermediate heat exchanger 5 to the additional heat exchanger or exchangers 7, and/or from the additional heat exchanger or exchangers 7 to the intermediate heat exchanger 5, may be performed by means of a pump, or by gravity, or by capillarity.

In this installation according to the invention, the vapor compression circuit 1 may be coupled with the secondary circuit 2 by the intermediate heat exchanger 5. Therefore, both the first heat transfer composition and the second heat transfer composition may pass through the intermediate heat exchanger 5.

When the installation is used for cooling a body or a fluid in a vehicle, the intermediate heat exchanger 5 is able to evaporate the first heat transfer composition and condense the second heat transfer composition, and the additional heat exchanger 7 is configured for transferring the heat from the body or the fluid to the second heat transfer composition.

When the installation is used for heating a body or a fluid in a vehicle, the intermediate heat exchanger 5 is able to condense the first heat transfer composition and evaporate the second heat transfer composition, and the additional heat exchanger 7 is configured for transferring heat from the second heat transfer composition to the body or the fluid, by condensing the second heat transfer composition.

In the context of the present patent application, each evaporation and each condensation may be total or partial.

An evaporation may therefore entail transition from the liquid state to the vapor state; or from the two-phase liquid/vapor state to the vapor state; or from the liquid state to the two-phase liquid/vapor state; or from one two-phase liquid/vapor state to another two-phase liquid/vapor state.

A condensation may therefore entail transition from the vapor state to the liquid state; or from the vapor state to the two-phase liquid/vapor state; or from the two-phase liquid/vapor state to the liquid state; or from one two-phase liquid/vapor state to another two-phase liquid/vapor state.

Evaporation and condensation may take place at constant temperature, or at variable temperature in the case of nonazeotropic mixtures of heat transfer compounds.

In some embodiments, in the intermediate heat exchanger 5, one composition (the first heat transfer composition or the second heat transfer composition) is at a temperature lower than the other; preferably, the temperature difference is less than 12° C., preferably less than 8° C., and more preferably less than 5° C. In the event of the temperature of a composition not being constant in the intermediate heat exchanger 5, the reference taken for estimating the above temperature difference is the median temperature between the inlet and the outlet of the intermediate heat exchanger.

In some embodiments, the installation and the method of the invention are adapted for the air conditioning of the passenger compartment of the vehicle.

In some embodiments, the installation and the method of the invention are adapted for the heating of the passenger compartment of the vehicle.

In some embodiments, the installation and the method of the invention are adapted for the cooling of the battery of the vehicle.

In some embodiments, the installation and the method of the invention are adapted for the heating of the battery of the vehicle.

In some embodiments, the installation and the method of the invention are adapted for the cooling of the electronic components of the vehicle.

In some embodiments, the installation and the method of the invention are adapted for the heating of the electronic components of the vehicle.

In some embodiments, the installation and the method of the invention are adapted for the air conditioning of the passenger compartment of the vehicle, and/or the heating of the passenger compartment of the vehicle, and/or the cooling of the battery of the vehicle, and/or the heating of the battery of the vehicle, and/or the cooling of the electronic components of the vehicle, and/or the heating of the electronic components of the vehicle.

### Heat Transfer Composition

The invention makes use of a first heat transfer composition and a second heat transfer composition, each heat transfer composition comprising a heat transfer fluid alone or in combination with lubricants and/or additives. The heat transfer fluid may comprise one or more heat transfer compounds.

The first heat transfer composition is present and circulates in the vapor compression circuit.

In some embodiments, the heat transfer fluid of the first heat transfer composition consists essentially, or consists, of HFO-1234yf.

In other embodiments, this heat transfer fluid comprises HFO-1234yf in a mixture with one or more other heat transfer compounds, such as hydrofluorocarbons and/or hydrofluoroolefins and/or hydrocarbons and/or hydrochlorofluoroolefins and/or CO₂.

The hydrofluorocarbons may especially include difluoromethane (HFO-32), pentafluoroethane (HFO-125), 1,1,2,2-tetrafluoroethane (HFO-134), 1,1,1,2-tetrafluoroethane (HFO-134a), 1,1-difluoroethane (HFO-152a), fluoroethane (HFO-161), 1,1,1,2,3,3,3-heptafluoropropane (HFO-227ea), 1,1,1-trifluoropropane (HFO-263fb), and mixtures thereof.

The hydrofluoroolefins may especially include 1,3,3,3-tetrafluoropropene (HFO-1234ze), in cis and/or trans form, and preferably in trans form; and trifluoroethylene (HFO-1123).

The hydrochlorofluoroolefins may especially include 1-chloro-3,3,3-trifluoropropene (HCFO-1233zd), in Z and/or E form, and preferably in E form. In some embodiments, this heat transfer fluid comprises at least 50% of HFO-1234yf, or at least 60% of HFO-1234yf, or at least 70% of HFO-1234yf, or at least 80% of HFO-1234yf, or at least 90% of HFO-1234yf, or at least 95% of HFO-1234yf, by weight.

The additives which may be present in the first heat transfer composition of the invention may especially be selected from nanoparticles, stabilizers, surfactants, tracer agents, fluorescent agents, odorants, and solubilizers.

The total amount of additives does not exceed 5% by weight, more particularly 4%, and more particularly still 3%, and very particularly 2% by weight, or even 1% by weight, of the first heat transfer composition.

In some embodiments, the HFO-1234yf contains impurities. When they are present, they may represent less than 1%, preferably less than 0.5%, preferably less than 0. %, preferably less than 0.05% and preferably less than 0.01% (by weight) relative to the HFO-1234yf.

One or more lubricants may be present in the first heat transfer composition. These lubricants may be selected from polyol esters (POE), polyalkylene glycols (PAG), or polyvinyl ethers (PVE).

The lubricants may represent from 1 to 50%, preferably from 2 to 40%, and more preferably from 5 to 30% (by weight) of the first heat transfer composition.

The heat transfer fluid of the second heat transfer composition may comprise one or more heat transfer compounds having a boiling point of 0 to 40° C., preferably of 5 to 35° C., and more preferably of 8 to 34° C.

By “boiling point of a compound” is meant the temperature at which the compound boils under a pressure of 1 bar.

In some embodiments, the heat transfer fluid of the second heat transfer composition has a boiling point of 0 to 40° C., preferably of 5 to 35° C., and more preferably of 8 to 34° C.

In the case of a mixture of several compounds, the boiling point of the mixture corresponds to the average between the boiling onset temperature and the final boiling temperature at a pressure of 1 bar.

In some embodiments, with the heat transfer compound or compounds having a boiling point of 0 to 40° C., they may be selected from hydrochlorofluoroolefins, hydrofluoroolefins, and combinations thereof.

In some embodiments, the hydrochlorofluoroolefins may be selected from 1-chloro-3,3,3-trifluoropropene (HCFO-1233zd) and 1-chloro-2,3,3,3-tetrafluoropropene (HCFO-1224yd), and combinations thereof.

The HCFO-1233zd may be in E and/or Z form.

Preferably, the HCFO-1233zd comprises more than 50 mol % of the E form, preferably more than 60 mol % of the E form, preferably more than 70 mol % of the E form, preferably more than 80 mol % of the E form, preferably more than 85 mol % of the E form, preferably more than 90 mol % of the E form, preferably more than 95 mol % of the E form, preferably more than 98 mol % of the E form, and more preferably more than 99 mol % of the E form. Preferably, it is entirely in E form.

The HCFO-1224yd may be in E and/or Z form.

Preferably, the HCFO-1224yd comprises more than 50 mol % of the Z form, preferably more than 60 mol % of the Z form, preferably more than 70 mol % of the Z form, preferably more than 80 mol % of the Z form, preferably more than 85 mol % of the Z form, preferably more than 90 mol % of the Z form, preferably more than 95 mol % of the Z form, preferably more than 98 mol % of the Z form, and more preferably more than 99 mol % of the Z form. Preferably, it is entirely in Z form.

In some embodiments, the hydrofluoroolefin may be 1,1,1,4,4,4-hexafluorobut-2-ene (HFO-1336mzz) in E and/or Z form.

The HFO-1336mzz may therefore comprise more than 50 mol % of the Z form, preferably more than 60 mol % of the Z form, preferably more than 70 mol % of the Z form, preferably more than 80 mol % of the Z form, preferably more than 85 mol % of the Z form, preferably more than 90 mol % of the Z form, preferably more than 95 mol % of the Z form, preferably more than 98 mol % of the Z form, and more preferably more than 99 mol % of the Z form. It may be entirely in Z form.

Alternatively, the HFO-1336mzz may comprise more than 50 mol % of the E form, preferably more than 60 mol % of the E form, preferably more than 70 mol % of the E form, preferably more than 80 mol % of the E form, preferably more than 85 mol % of the E form, preferably more than 90 mol % of the E form, preferably more than 95 mol % of the E form, preferably more than 98 mol % of the E form, and more preferably more than 99 mol % of the E form. It may be entirely in E form.

In some embodiments, the heat transfer compounds used in the second heat transfer composition have a latent heat of evaporation at 20° C. of more than 100 kJ/kg, preferably more than 110 kJ/kg, more preferably more than 120 kJ/kg, more preferably more than 130 kJ/kg, more preferably more than 140 kJ/kg, more preferably more than 150 kJ/kg, and more preferably more than 160 kJ/kg.

The latent heat values of the heat transfer compounds used preferentially in the second composition as heat transfer fluid are presented in the table below for a temperature of 20° C. The highest latent heat is observed for HCFO-1233zd(E).

| | | | Latent heat |
|---|---|---|---|
| Heat transfer | Temperature | Pressure | of evaporation |
| composition | (° C.) | (bar) | (kJ/kg) |
| HCFO-1233zd(E) | 20 | 1.07 | 194 |
| HFO-1336mzz(Z) | 20 | 0.6 | 171 |
| HFO-1336mzz(E) | 20 | 1.66 | 141 |
| HCFO-1224yd(Z) | 20 | 1.26 | 164 |

In some embodiments, the heat transfer fluid of the second heat transfer composition comprises a single heat transfer compound.

In some embodiments, the heat transfer fluid of the second heat transfer composition may be a binary mixture of heat transfer compounds.

In some embodiments, the heat transfer fluid of the second heat transfer composition may be a ternary mixture of heat transfer compounds.

The second heat transfer composition is present and circulates in the secondary circuit.

In some embodiments, the second heat transfer composition undergoes neither compression nor expansion.

In some embodiments, the second heat transfer composition comprises at least 50% of heat transfer fluid, or at least 60% of heat transfer fluid, or at least 70% of heat transfer fluid, or at least 80% of heat transfer fluid, or at least 90% of heat transfer fluid, or at least 95% of heat transfer fluid, by weight.

In some embodiments, the heat transfer fluid of the second heat transfer composition consists essentially, or consists, of heat transfer compounds.

The additives which may be present in the second heat transfer composition of the invention are the same as those described above in connection with the first heat transfer composition, and are subject to the same concentration ranges.

1. A method for cooling a body or a fluid in a motor vehicle, by means of a system comprising a first heat transfer composition circulating in a vapor compression circuit and a second heat transfer composition circulating in a secondary circuit, the method comprising:
the transfer of heat from the body or fluid to the second heat transfer composition, leading to the evaporation of this second heat transfer composition;
the transfer of heat from the second heat transfer composition to the first heat transfer composition, leading to the condensation of the second heat transfer composition and the evaporation of the first heat transfer composition.

2. A method for heating a body or a fluid in a motor vehicle, by means of a system comprising a first heat transfer composition circulating in a vapor compression circuit and a second heat transfer composition circulating in a secondary circuit, the method comprising:
the transfer of heat from the second heat transfer composition to the body or fluid, leading to the condensation of this second heat transfer composition;
the transfer of heat from the first heat transfer composition to the second heat transfer composition, leading to the evaporation of the second heat transfer composition and the condensation of the first heat transfer composition.

3. The method as claimed in claim 1, wherein the fluid is air.

4. The method as claimed in claim 1, wherein the first heat transfer composition comprises 2,3,3,3-tetrafluoropropene.

5. The method as claimed in claim 1, wherein the second heat transfer composition comprises one or more heat transfer compounds having a boiling point of 0 to 40° C.

6. The method as claimed in claim 1, wherein the second heat transfer composition is at an essentially uniform pressure in the secondary circuit.

7. The method as claimed in claim 1, wherein the motor vehicle is an electric or hybrid vehicle.

8. An installation for cooling and/or heating a body or a fluid in a motor vehicle, comprising:
a first heat transfer composition circulating in a vapor compression circuit; and
a second heat transfer composition circulating in a secondary circuit;
the vapor compression circuit being coupled with the secondary circuit by an intermediate heat exchanger, so as to evaporate the first heat transfer composition and to condense the second heat transfer composition, and/or to condense the first heat transfer composition and to evaporate the second heat transfer composition; and the installation comprising an additional heat exchanger configured for transferring the heat of the body or fluid to the second heat transfer composition by evaporating the second heat transfer composition, and/or configured for transferring heat of the second heat transfer composition to the body or fluid by condensing the second heat transfer composition.

9. The installation as claimed in claim 8, wherein the vapor compression circuit is reversible and further comprises means for reversing its operation.

10. The installation as claimed in claim 8, wherein the circulation of the second heat transfer composition in the secondary circuit after condensation thereof is performed by means of a pump, or by gravity, or by capillarity.

11. The installation as claimed in claim 8, wherein the secondary circuit comprises a plurality of additional heat exchangers, configured for cooling and/or heating a plurality of bodies or fluids.

12. The installation as claimed in claim 8, adapted for the air-conditioning of the passenger compartment of the vehicle, and/or the heating of the passenger compartment of the vehicle, and/or for the cooling of the battery of the vehicle, and/or the heating of the battery of the vehicle and/or the cooling of the electronic compounds of the vehicle, and/or the heating of the electronic compounds of the vehicle.

13. The installation as claimed in claim 8, wherein the first heat transfer composition comprises 2,3,3,3-tetrafluoropropene.

14. The installation as claimed in claim 8, wherein the second heat transfer composition comprises one or more heat transfer compounds having a boiling point of 0 to 40° C.

15. The method as claimed in claim 5, wherein the second heat transfer composition is chosen from hydrochlorofluoroolefins, hydrofluoroolefins, and combinations thereof.

16. The method as claimed in claim 5, wherein the second heat transfer composition is chosen from 1-chloro-3,3,3-trifluoropropene; 1-chloro-2,3,3,3-tetrafluoropropene, and 1,1,1,4,4,4-hexafluorobut-2-ene.
